(19) United States
(12) Patent Application Publication
(10) Pub. No.: US 2014/0089033 A1
(43) Pub. Date: Mar. 27, 2014

(54) METHODS AND SYSTEMS FOR PROVIDING OFFERS IN A CONTENT WORKFLOW

(71) Applicant: THOMSON LICENSING, (US)

(72) Inventor: Nicholas Edward SNODGRASS, Los Gatos, CA (US)

(73) Assignee: THOMSON LICENSING, Issy de Moulineaux (FR)

(21) Appl. No.: 13/733,914

(22) Filed: Jan. 4, 2013

Related U.S. Application Data
(60) Provisional application No. 61/584,128, filed on Jan. 6, 2012.

(51) Int. Cl. G06Q 10/06

(52) U.S. Cl. CPC G06Q 10/06316
USPC 705/7.26

(57) ABSTRACT

Methods and systems for providing a content workflow for media assets (e.g., video, audio and the like) include the ability to offer such content for sale to consumers. The invention can be implemented in a client/server environment where such media assets can be ingested and processed electronically prior to the offers for sale. According to an exemplary embodiment, a method for operating a system includes: receiving, via the system, a metadata file for at least one of audio and video content represented by a title; and generating, via the system and in response to the metadata file, one or more software elements representing an offer to sell the content.

### CROSS REFERENCE TO RELATED APPLICATION

This application claims priority to and all benefits accruing from two (2) provisional applications filed in the United States Patent and Trademark Office on Jan. 6, 2012, and there assigned Ser. Nos. 61/584,127 and 61/584,128.

### BACKGROUND OF THE INVENTION

1. Field of the Invention

The present invention generally relates to methods and systems for providing a content workflow for media assets (e.g., video, audio and the like) including the ability to offer such content for sale to consumers. The invention may be implemented in a client/server environment or a peer-to-peer environment where such media assets can be ingested and processed electronically prior to the offers for sale.

2. Background Information

The process of creating and producing professional quality media assets, such as audio and/or video content, and distributing such content to consumers involves a number of different steps and/or entities, and is evolving. In such a process, content is processed in a workflow that may include various functions, such as encoding, transcoding, quality control, encryption and delivery.

At present, it is believed that such a workflow and delivery process can be made easier and more efficient for each of the entities involved. Accordingly, there is a need in the art to provide improved methods and systems for providing a content workflow for media assets, such as audio and/or video content, including the ability to offer such content for sale to consumers. The present invention described herein addresses these and/or other issues.

### BRIEF SUMMARY OF THE INVENTION

In accordance with an aspect of the present invention, a method for operating a system is disclosed. According to an exemplary embodiment, the method comprises receiving, via the system, a metadata file for at least one of audio and video content represented by a title; and generating, via the system and in response to the metadata file, one or more software elements representing an offer to sell the content.

In accordance with another aspect of the present invention, a system is disclosed. According to an exemplary embodiment, the system comprises means, such as an input, for receiving a metadata file for at least one of audio and video content represented by a title; and means, such as a processor, for generating, in response to the metadata file, one or more software elements representing an offer to sell the content.

The aforementioned brief summary of exemplary embodiments of the present invention is merely illustrative of the inventive concepts presented herein, and is not intended to limit the scope of the present invention in any manner.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 shows a high level block diagram of a system for providing a content workflow and for managing and presenting offers for content according to exemplary embodiments of the present invention;

FIG. 2 shows a block diagram of a relevant portion of the content workflow of FIG. 1 according to exemplary embodiments of the present invention; and

FIG. 3 shows another block diagram of a relevant portion of the content workflow of FIG. 1 according to exemplary embodiments of the present invention.

The exemplifications set out herein illustrate preferred embodiments of the invention, and such exemplifications are not to be construed as limiting the scope of the invention in any manner.

### DETAILED DESCRIPTION OF THE PREFERRED EMBODIMENTS

It is to be understood that the present invention may be implemented in various forms of hardware, software, firmware, special purpose processors, or a combination thereof. Special purpose processors may include application specific integrated circuits (ASICs), reduced instruction set computers (RISCs) and/or field programmable gate arrays (FPGAs). Preferably, the present invention is implemented as a combination of hardware and software. Moreover, the software is preferably implemented as an application program tangibly embodied on a program storage device. The application program may be uploaded to, and executed by, a machine comprising any suitable architecture. Preferably, the machine is implemented on a computer platform having hardware such as one or more central processing units (CPU), a random access memory (RAM), and input/output (I/O) interface(s). The computer platform also includes an operating system and microinstruction code. The various processes and functions described herein may either be part of the microinstruction code or part of the application program (or a combination thereof), which is executed via the operating system. In addition, various other peripheral devices may be connected to the computer platform such as an additional data storage device and a printing device.

It is to be further understood that, because some of the constituent system components and method steps depicted in the accompanying figures are preferably implemented in software, the actual connections between the system components (or the process steps) may differ depending upon the manner in which the present invention is programmed. Given the teachings herein, one of ordinary skill in the related art will be able to contemplate these and similar implementations or configurations of the present invention.

To enhance understanding of the inventive principles disclosed herein, the following terms and definitions, which may be referred to herein, are provided.

AES-128—An encryption standard that is the base of all DRM technologies. AES-128 can be used as a DRM but requires customization and proprietary development.
Content Preparation—The process of encoding from source, creating lesser bit-rate transcodes, wrapping the transcoded outputs in their deliverable format.
DRM—Digital Rights Management is a technology that protects content from being pirated through a system of encryption and secured license keys that allow client media players to playback content.
Entitlement—A digital usage right that is granted after a sale is made for the right to view a particular piece of content. These are stored in the Digital Locker and have distribution restrictions associated to said entitlement depending on content provider and entitlement type (VOD, EST, etc.).
EST—Electronic Sell Through is a content distribution model where consumers purchase the rights to content permanently (similar to purchasing a DVD).
Extra Content—Extra assets that are delivered with the Source Material that may include bonus features and applications.
F4F—File format for Adobe's on-demand HTTP dynamic streaming components; its specification describes how content is divided into segments and fragments, where each fragment has bootstrap information to provide cache management.
Flash Access—An Adobe owned Digital Rights Management Technology
HLS—HTTP Live Streaming (also known as HLS) is an HTTP-based media streaming communications protocol implemented by Apple Inc. as part of their QuickTime X and iPhone software systems.
MAL—Material Access Letter, outlines all of the titles to which Content platform is granted access in order to procure and deliver assets (“material”).
MediAffinity—A proprietary platform developed by Technicolor that automates highly complex content preparation workflows that include: encoding, transcoding, automated QC, encrypting and delivery.
Mezzanine—A “mastered” high resolution, high bit-rate video file that is used to create smaller, consumer ready video files.
OTT—Over-the-top, VOD services from an alternative provider, such as YouTube
PlayReady—A Microsoft owned Digital Rights Management technology
QA/QC—Quality Assurance/Quality Control is a process that is completed through either automated testing or manual testing that validates the quality of an output file.
VOD—Video On Demand is a content distribution model where consumers purchase content for a period of time (generally 24 to 48 hours). VOD can also be generically used to describe a service that delivers videos to consumers.
SIFT—A MediAffinity workflow that ingests content Source Material. This process pre-qualifies the material to ensure it complies with requirements, normalizes the audio if out of parameter, and masters the file into a digital Mezzanine format.
Smooth Streaming—Microsoft's IIS Media Services extension that enables adaptive bit rate streaming of media to Silverlight and other clients over HTTP
Source Material—Raw un-mastered digital or tape assets that are generally a very high bit-rate. These assets are strictly used business to business (B2B) and require post-production work and processing to make suitable for consumer use.
Widevine—A Google owned Digital Rights Management technology.

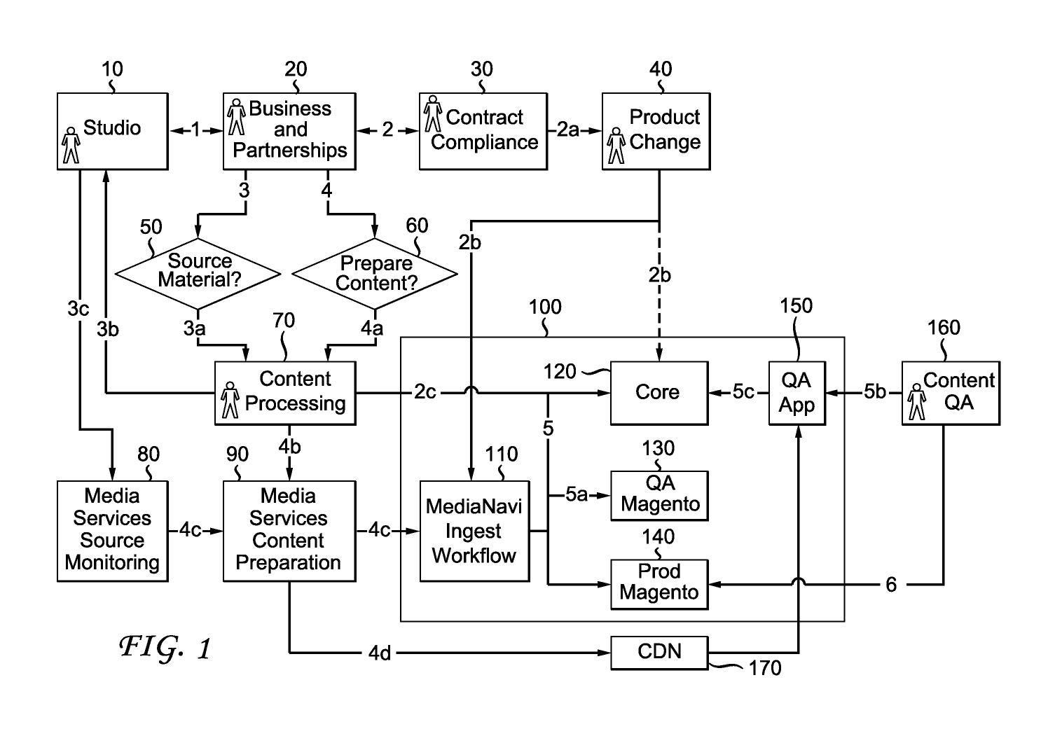

Referring now to the drawings, and more particularly to FIG. 1, a high level block diagram of a system for providing a content workflow according to exemplary embodiments of the present invention is shown. The exemplary system of FIG. 1 may be implemented in a client/server environment, and comprises a plurality of blocks including studio partner block 10, business and partnerships block 20, contract compliance block 30, product change block 40, decision blocks 50 and 60, content processing block 70, media services source mastering block 80, media services content preparation block 90, content workflow management block 100, content quality assurance (QA) block 160 and content distribution network (CDN) block 170. Content workflow management block 100 comprises ingest workflow block 110, core block 120, QA magento block 130, product magento block 140 and QA application block 150.

For purposes of example and explanation, the following description of exemplary embodiments of the present invention may be described with specific reference to the aforementioned blocks of FIG. 1.

### Workflow Description

According to the exemplary embodiments described herein, content workflow refers to the process where one or more distribution agreements are made with one or more studio partners (e.g., block 10) to source, prepare and distribute content through a content delivery system. The content delivery system of the present invention adheres to the rules and restrictions of a pre-negotiated distribution agreement through a system of rules, offers and DRM profiles.

Also according to exemplary embodiments, a given studio partner may be new to the content platform and delivery system of the present invention, and will require on-boarding with a content processing team. Functional steps and/or interactions between the blocks in FIG. 1 will be described with specific reference to items 1-6 and their respective sub-parts, as shown in FIG. 1 and discussed below.

1. Initial Business Negotiations:

The content platform business negotiates a license agreement with studio partner 10 to distribute content either through EST, VOD or Subscription Video-on-Demand (SVOD) models. The business negotiates restrictions and other binding agreement criteria that drive business rules in the content platform system which impacts later steps in the workflow.

2. Product Changes:

At some point in the negotiations prior to the license agreement being signed the agreement is reviewed by a group made up of product, architecture and legal functions to determine if the content platform system can support the restrictions. If some restrictions are not technological feasible then the compliance team will push back on the requirements. Otherwise:

a. New rule creation to adhere to distribution restrictions and other binding terms in the agreement are routed through the product change team where the work is defined, scoped and scheduled.

b. After the work is scheduled, engineering implements new rules in the content platform workflow and device/asset modules.

c. For existing rules in the device/asset module, the content processing team provides updates.

3. Content Sourcing:

At the point that content platform business has a term sheet from the studio partner 10 and a decision meeting is scheduled to determine if it is appropriate to start sourcing based on the level of confidence that the deal will be signed (i.e., block 50).

a. If it is decided to move forward, a MAL is requested from the studio partner 10 through the content processing team. Business and partnerships block 20 coordinates for an operational contact at the studio for content processing. Additionally, content processing forecasts delivery with the media services team.

b. Studio partner 10 begins to source material.

c. Media services block 80 starts ingesting and mastering source content.

4. Content Order Processing:

Content platform business will kick off another meeting to determine if it is appropriate to start preparing content in the end formats that will be delivered to consumers. According to an exemplary embodiment, this decision (i.e., block 60) is based on the status of the “Long Form” negotiations, and if the team is highly confident the deal will be signed.

a. If the decision is made to prepare content and the content processing begins forecasting the priority of titles required out of MediAffinity from Technicolor (i.e., block 90) by developing a list with Provider ID, Technicolor IDs, MediAffinity barcodes and Title. If the decision is made not to prepare content then processing stops.

b. The request is submitted to MediAffinity.

c. Mastered mezzanines are de-archived from cold storage and MediAffinity begins processing.

d. MediAffinity outputs video files and deploys them via the Aspera connection to content platform's CDN partner.

e. MediAffinity delivers a metadata file into the appropriate providers folder that includes title, Technicolor ID, MediAffinity barcode, video definition, DRM, etc. This will help tell the workflow module how to ingest the metadata into the device/asset module as well as magento.

5. Ingest and QA:

As metadata files are delivered from MediAffinity into the appropriate provider folder the content platform ingest workflow module begins processing and applying rules to each title (representing content) that is ingested into the system. The workflow updates the core with all the locations of the video files on the CDN as well as generates the appropriate policies.

a. The ingest workflow module starts creating nearly identical offers based on the rules into both the production and QA magento. The only difference is that in the QA magento instance the offers will automatically be active for QA. The production magento offers will require a content processing person to update the offer to active.

b. Now that the content has been almost fully ingested into the system the content QA team will use a special version on the content platform application to check playback of the video assets on the CDN.

c. Through QA application the team selects a title, purchases, and plays. This kicks off a call to requested a URL from the device/asset module for playback from the CDN.

d. After the URL is retrieved the QA version of the application makes the request through CDN 170 and the video file starts playing back after the entitlement is checked and DRM license key is served through the content platform backend.

6. Publish:

Now that the title (representing content) has been fully ingested and quality checked through the content platform system, a content processing individual updates the production magento instance to publish every offer for that said title.

### Detailed Content Flow

According to exemplary embodiments, the content processing team includes a tool that will help source raw material as well as place orders in MediAffinity to process content. This order processing will be a data service driven where with a few key metadata elements MediAffinity will create the appropriate files based on a predefined workflow. The following section will describe this process starting from receiving the confirmation from the business team of the business and partnerships module to start sourcing material to final delivery of the video assets to the CDN and metadata to the content platform content workflow module.

### Content Sourcing

Sourcing begins once content platform business team of the business and partnerships module approves via item 3 from above. The following will occur:

1. The content processing team will coordinate with studio material procurement (generally an operations function) to coordinate a digital transfer mechanism with a media service team. Additionally, the content processing team communicates the content source preference sheet.

2. Once the digital transfer mechanism is established, the content processing team will prioritize with the studio which titles (representing content) should be delivered first and forecast the delivery to the media service team. The priority will be communicated to the media service team with the following:
Title
Technicolor ID (content ID)
Provider ID (studio)
Sub-Provider ID (sub-studio)
SD Source Flag—this flag indicates to the Media Service team that they should expect a SD source delivered from the Studio
HD Source Flag—this flag indicates to the Media Service team that they should expect a HD source delivered from the Studio.

These items will be pulled from the content platform catalogue.

Additionally, the team will ensure that there are not multiple Technicolor IDs to the one single title.

3. As source material is delivered to MediAffinity, it will be processed by the priority set by the content processing team. Once the material is ingested, MediAffinity delivers a metadata file containing the following elements:
Title
Technicolor ID (content ID)
Provider ID (studio)
Sub-Provider ID (sub-studio)
MediAffinity Barcode
SD Source Confirmation Flag
HD Source Confirmation Flag
Flags for extra material included with source:
   Extract Content
   Closed Captioning
   Subtitles

### Content Ordering Process

At this point source material is being delivered into MediAffinity and is continuously ingested into the system. The actual order has not been submitted to the media service team and this will not be done until content platform business has received the studio “long form” and has made the decision to move forward in processing.

1. Once the metadata file is received this will be fed into the content flow tracking tool. The business team of the business and partnerships module will make the decision to begin the ordering process. If there was an exception to the SD/HD Source flags where a source is missing and was expected to be delivered, the content Processing team will work to resolve with the studio partner. According to an exemplary embodiment, the following is submitted in the ordering process.
Order template ID—media services will supply once workflow is completed.
Content platform Order ID
Provider ID
Sub-Provider ID (sub-studio)
Technicolor ID
External ID—this is the provider's identification for title (representing content) and may be used for royalty reporting, etc.
MediAffinity Barcode
SD Source Flag
SD Source Confirmation Flag
HD Source Flag
HD Source Confirmation Flag
Priority Delivery Date

2. Once the above information is submitted, MediAffinity will begin processing the orders. In the MediAffinity workflow, updates will be sent every 24 hours, or in accordance with another pre-defined time period.

3. MediAffinity outputs video files and deploys them via Aspera or Aspera-like connection to Content platform's CDN partner.

4. MediAffinity delivers a metadata file that describes the various assets for one title (representing content) into a “hot folder” with the following elements:
Title
Technicolor ID
Provider ID
Sub-Provider ID (sub-studio)
MediAffinity barcode
Asset filenames
Fulfilment URL
File size (bytes)
File checksum (from Aspera)
Container type (MP4, F4F, transport stream (TS), etc)—this will tell us the streaming type
Encryption type (Flash Access, AES-128, Widevine, etc.)
Asset Resolutions
Asset Bitrates
Bitrate units
Scan type (Progressive, Interlaced)
Video frame rate
Definition type (HD, SD, etc.)
VBR/CBR
Audio format
Audio channels
Audio sampling

5. Another metadata file is delivered describing the mezzanine that was created through the SIFT workflow. This metadata is held strictly for information purposes in case reorders have to be made in the future.
Title
Technicolor ID
Provider ID
Sub-Provider ID (sub-studio)
MediAffinity barcode
Mezzanine Definition (HD, SD) and Resolution
Mezzanine Codec and Container Type
Mezzanine Bit-Rate
Mezzanine Audio Format, Channels and Sampling

6. Additionally, as files are encrypted in the MediAffinity flow encryption keys are delivered to the content platform's key management servers.

### Ingest Workflow

According to exemplary embodiments, as metadata files are delivered from MediAffinity into a hot folder, the Content platform Ingest Workflow acts on the metadata with various rules based on the Provider ID.

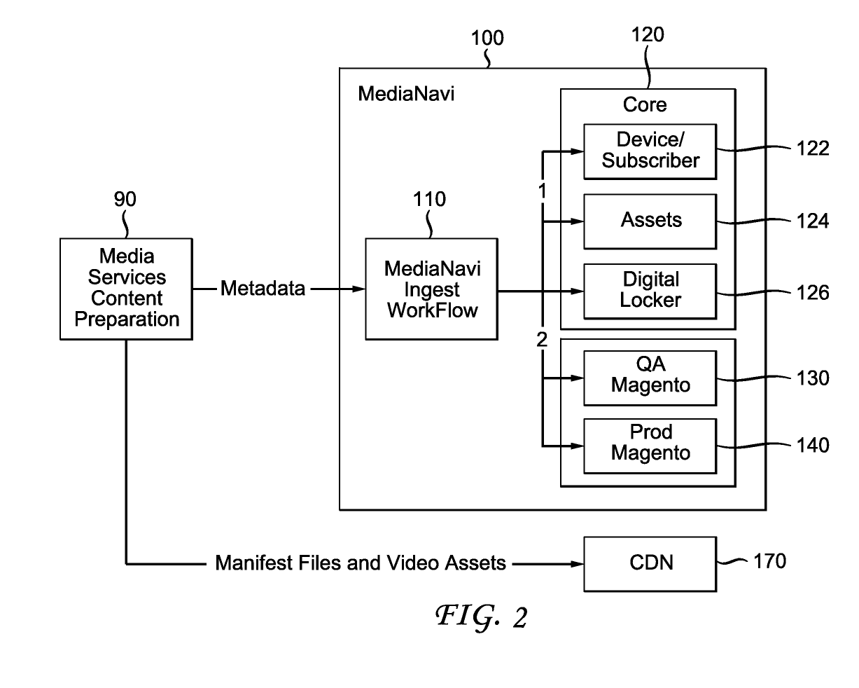

Referring now to FIG. 2, a block diagram of a relevant portion of the content workflow of FIG. 1 according to exemplary embodiments of the present invention is shown. Functional steps and/or interactions between the blocks in FIG. 2 will be described with specific reference to items 1-2 as shown in FIG. 2 and discussed below.

1. As metadata flows is delivered to a hot folder from MediAffinity (i.e., block 90), ingest workflow block 110 will begin generating new software elements in the system based on the Provider ID and pre-existing rules and policies. There is both a production core and QA core that receive these new elements.

a. Device/Subscriber block/module 122—Device/Subscriber block/module 122 is dependent on the Provider ID. This is where elements will be created for each asset to restrict distribution to numbers of devices, households or accounts.
Device restrictions for VOD playback—Limits the number of devices that can playback a VOD entitlement.
Device restriction for EST playback—Limits the number of devices that can playback an EST entitlement.
User and Device restrictions—Limits the number of devices that a user can bind to their account.
# of De-authorization/Authorizations of Authorized Device—Limits the number of devices that a user can bind and unbind to their account in a given period and has a time penalty if a user meets this restriction that lasts a certain amount of days before this limit resets.

b. Assets block 124—This area will only house the location of assets on the CDN 170 as well as which device profiles they are bound to. After entitlement checking this is the module that will deliver the URL to the application.

c. Digital Locker block 126—All use entitlements are stored in the digital locker. The ingest workflow applies distribution policies in this location such as:
Geo-restrictions—by country and state/province (note that some content is restricted distributing even at the state/province level).
VOD Viewing Windows—Once a title (representing content) is purchased a consumer will have only 30 days to initiate playback. If playback is not initiated within 30 days then the entitlement will be revoked in the digital locker.
VOD Playback Window—A period of time commencing from initiation of playback that allows the consumer to view the content as many times as they would like, pending distribution restrictions from the device/subscriber module.

2. Ingest workflow block 110 starts creating nearly identical offers to sell the content based on the rules and provides the same to both QA magento block 130 and production magento block 140. The only difference is that in the QA magento instance the offers will automatically be active for QA. The production magento offers will require a content processing person to update the offer to an active status. Further exemplary details regarding offers will be provided later herein.

### Quality Assurance

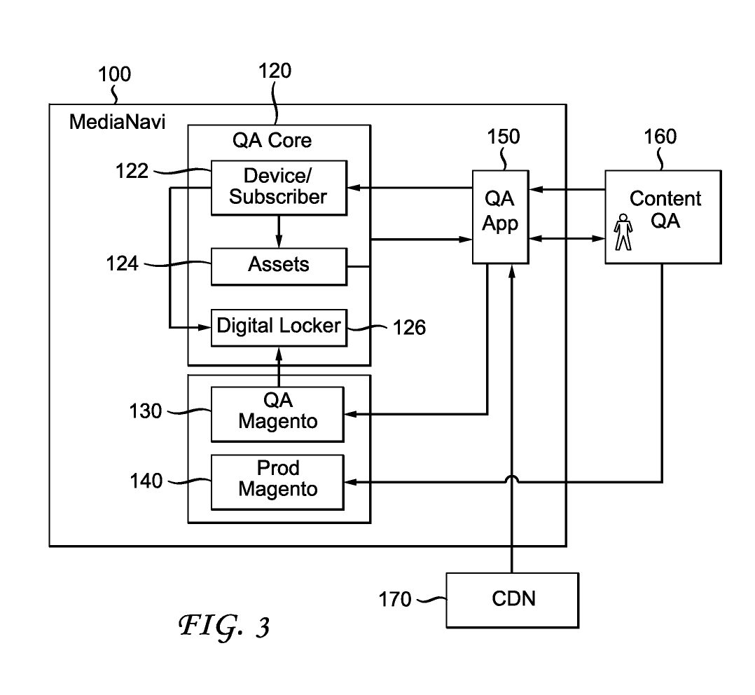

According to exemplary embodiments, quality assurance (QA) is a process of testing consumer-ready content (e.g., videos, etc.) on end-use devices to ensure that the quality is of an acceptable level. It is unrealistic to think that all video files will be tested against all devices as that would require an amount of resources and time as that could hinder or break the business model. Instead, the preferred method is to conduct testing on a subset of devices and video files. FIG. 3 shows a block diagram of a relevant portion of the content workflow of FIGS. 1 and 2 that is employed for the QA process according to exemplary embodiments of the present invention, where like reference numbers represent the same or similar blocks.

### Content Ingest Tool

According to exemplary embodiments, the content ingest tool is a supply chain tracking system that allows the content ingest team and customer service to accomplish the following:

1. Facilitate the tracking of content in the system (sourced, processed, ingested, QA'd, published) as described in all steps above.

2. Parameters of existing rules and policies for providers can be updated and tracked.

3. Update and track order data flow (MediAffinity Barcode, Technicolor (TCH) ID, Provider ID and Title mapping).

4. Order placement and order status from MediAffinity.

5. Mass Rule/Policy updates for Providers—for example, UV added as an offer to provider catalogue.

6. Auditing—all updates/changes need to be tracked.

### Content Preparation Tool

According to exemplary embodiments, the content ingest tool gives the user the ability to track content preparation starting from sourcing to the eventual delivery to CDN 170 of FIG. 1-3.

Views

The Content Ingest Tool shall include at least four (4) views:

1. List View

2. Detailed View

3. Rules View

4. Policies View

### Search

According to exemplary embodiments, the Ingest Tool is user-friendly with the basic functionality to search by at least one or more of the following:
Title
Technicolor ID
Provider ID
Sub-Provider ID

### Results

According to exemplary embodiments, depending on the search query different results will be displayed.

Detailed View:
Exact match of search against data in system (searched for Mission Impossible 3, data in system is Mission Impossible 3) (e.g., no caps detection)
Only match of search against data in system (searched for Break Up, only match in system is The Break Up)

List View:

According to exemplary embodiments, content in order to be ingested may have certain requirements placed on the attributes of such content including parameters such as:

Video Codec
Video Profile & Level
Video Bit Rate (if applicable)
Frame Rate
Aspect Ratio
Display Aspect Ratio
Chroma
Frame Size
Subtitles
Audio/Video Duration
Audio Codec
Audio Sample Rate
Audio Bit Depth
Audio Channels
Target Loudness/db
Peaks/db

### Offer Management

The following portion of the detailed description describes exemplary embodiments for providing and managing the process of offering content for sale and distribution to consumers. “Sale” may include an effective rental of the content. That is, the “sale” of content may be the ability of a user/viewer/subscriber/purchaser to view/render the content for a period of time or to view/render the content a number of times. “sale” may also include the sale of the content just as a user/viewer/purchaser may buy a disc of the content. These exemplary embodiments may be implemented in the exemplary content workflow system shown in FIGS. 1-3 and described above.

According to exemplary embodiments, the system (e.g., content workflow management block 100) implements an offer module where various offers for content can be automatically created (e.g., via one or more processors associated with core block 120 of FIGS. 1-3) in response to a received metadata file as part of the overall content workflow. The resultant offers may be made to users/consumers based on a variety of criteria. For example, some offers can be dependent on studio-only offers (e.g., Paramount, Warner Brothers (WB), Disney and the like). Other offers, for example, can entail having a reduction in price if a user decides to buy the same content in a variety of formats at the same time (e.g., UV, Blu-Ray, etc.).

One exemplary embodiment of the present offer management system (OMS) considers media that is made available through different sources, where, even though a user may have a first movie ROCKY I through a first media service/provider (e.g., (TUNES), and a second movie ROCKY II through a second media service/provider (e.g., AMAZON), the offer management system can offer a reduced price for a third movie ROCKY III through a third media service. The present offer system recognizes that users can get similar content from different providers, hence by keeping track of what content comes from where, the offer system can push offers to users to push further media asset purchases based on criteria such as having content be part of the same series, from the same studio, having the same actors, and the like.

That is, it may be in a content creator/studio's interest to push the sale of their content which is not limited to a specific content provider or service. For example, the upselling of content occurs on other attributes aside from whether or not the content came from ITUNES, AMAZON, and the like. Alternatively, when content comes from a particular source (e.g., (TUNES), the present offer system can be used to offer better prices from other sources (e.g., AMAZON) to drive purchase of additional content from specific sources.

### Offer Creation

Offers will initially be created in the system manually through a portal by offer management administrators. Additionally this portal can be used by studios (with a different security/account level) to create promotions. Offers can be created as early as the MAL receipt from the studio and made available to the consumer as early as the offer window outlined by business agreements. The business agreements may also provide termination dates and times for certain offers.

According to exemplary embodiments, offers support multiple devices so that when, for example, consumers purchase content for a title or episode on an iPad format, they will also be able to play it on their television in another format. Also according to exemplary embodiments, the system is automated so that when a prepared piece of content (represented by a title) is ingested, one or more software elements representing an offer to sell such content are automatically created via one or more system processors in accordance with predefined settings.

According to exemplary embodiments, there are at least two (2) quality tiers/formats available for each title of content, including standard-definition (SD) and high-definition (HD) formats. Also according to exemplary embodiments, previously purchased HD offers gain a consumer usage rights to all file formats available (e.g., to reduce file size delivery to mobile devices). Also according to exemplary embodiments, purchased SD offers only gain usage rights to SD and lower bit-rates even when attempting to play on an HD television or other HD output device. Also according to exemplary embodiments, in cases where there is no available HD source for a given title (representing content) (e.g., Gone with the Wind) it may be appropriate to only provide an SD offer. A true HD transcoded version of such a given title (representing content) may also, for example, be created and provided to a consumer for a prescribed or negotiated fee.

Also according to exemplary embodiments, the OMS of the present invention supports 3D offers as well, which similar to HD provides usage rights to the consumer to 3D, HD, SD, Portable and 3GP formats (see Table 1 below, which may also be presented to consumers as a user interface menu).

TABLE 1
Exemplary Offer Quality Tiers/Formats

| | | | | |
|---|---|---|---|---|
| 3D Version | HD Version | SD Version | Portable | 3GP |

SD Offer
HD Offer
3D Offer

According to exemplary embodiments, offers may be presented to the consumer in accordance with several different “flavors” and/or formats. For example, the OMS of the present invention supports both rental and Electronic Sell Through (EST) offers (with an ultraviolet variation). Subscription offers may be provided as well. The OMS of the present invention also supports other types of offers, such as “Seasons Pass” and “Pre-Order” offers, as shown below in exemplary Table 2 which lists a plurality of exemplary offers, and may also be presented to consumers as a user interface menu (e.g., during a selection process).

TABLE 2
Exemplary Offers in OMS

| | | |
|---|---|---|
| SD | HD | 3D |

Rental
EST
EST Ultraviolet
Subscription
Season Pass
Pre-Order

### Rental Offers

According to exemplary embodiments, rental offers grant the user/consumer usage rights for a predefined amount of time, and the level of usage rights may, for example, be dependent on which quality tier has been purchased (e.g., SD/HD/3D).

Also according to exemplary embodiments, the system includes the flexibility to assign different rental windows that will synchronize with DRM Profiles and the digital locker (entitlement creation). There are at least two (2) different types of windows for rented content, including types (1) and (2) described below:

(1) Availability to Start Viewing Window: When a consumer purchases a rental they will have the option to save it for later. This window is generally set to 30 days (e.g., as default), but the system includes the flexibility to set it to any amount.

(2) Viewing Window: If the user has elected to start viewing the content they then have a finite amount of time to finish viewing the content. During this window they can watch the content unlimited times. Generally this window is set to either 24 or 48 hours (e.g., as default), but the system includes the flexibility to set the window to any desired amount.

### EST Offers

According to exemplary embodiments, EST offers grant the user permanent usage rights to that particular piece of content at the purchased quality tier. There are EST offers that are created as an ultraviolet (which is simply an enhanced EST offer). There are at least two reasons for this. First, not all studios may elect to participate in ultraviolet. Secondly, ultraviolet compliant offers may be branded differently to consumers. In cases where there is an EST UV offer, it may be unlikely there will be a need for a regular EST offer.

### Subscription Offers

According to exemplary embodiments, subscription offers allow the consumer to purchase services, such as OTT linear television and cable, etc., and support for a-la-carte channel subscriptions.

### Season Pass Offers

According to exemplary embodiments, “Season Pass” offers are for episodic content that is currently in the television airing release window. For example, consumers are able to purchase a “Season Pass” to a television series' season, and as the episodes in that season are shown on their first run air date, they are made available in that consumer's digital locker (e.g., block 126 in FIGS. 2 and 3). According to exemplary embodiments, at least two models are considered basic for business reasons: rental and EST.

### Pre-Order Offers

According to exemplary embodiments, content that has yet to be published in a VOD distribution window are made available as a pre-order offer. Consumers are able to purchase EST or rental offers in this window. Special price adjustments and/or additional bundled content may also be provided to add extra value in pre-ordering.

### Edit/Update Offers

According to exemplary embodiments, the system is operative to conduct mass edit/updates to offers by the various fields. For example, if an offer management administrator wants to update all Warner Brothers EST HD offers, they can do so in a robust easy-to-use manner. All edit/update actions are tracked in the system so that they can be audited.

### Offer Metadata

According to exemplary embodiments, all offers contain at least the following metadata for administrative purposes (note: this metadata may not be consumer facing):

Technicolor ID

Provider (e.g., Paramount, etc.)

Checksum

Title

Size

Location Path

Workflow Type

Definition

DRM Profile (rental/EST)

### Enhanced System Metadata

According to exemplary embodiments, the system is operative to support robust metadata sets for each offer so that there is more flexibility in the types of promotions and bundling available. Ideally, this metadata will be fed into the OMS by a Navi catalogue pre-processor.

### Automation

According to exemplary embodiments, due to the potentially massive amount of offers that need to be created and the amount of titles (representing content) that need to be ingested, there is a need for some level of automation in the offer creation flow. At a minimum, the offers are preferably preformatted to the above set of metadata.

### Promotions

According to exemplary embodiments, promotions allow for studios and offer management administrators to curate offers for the purposes of merchandising content to consumers to drive more sell-through and uptake for the business, as well as deliver more value to the consumer.

### Bundling

According to exemplary embodiments, the system is operative to support bundling of any combination of movies, as well as episodes in a season and seasons in a television series. The flexibility of bundling will drive special offers to the consumer, as well as enhance basic offers. According to an exemplary embodiment, bundling may be fairly simple and require manual processing due to the available metadata in the offer, such as:

Provider (studio)

Episodes in a Season

Seasons in a Series

Title to Title

Quality Tiers

According to other exemplary embodiment, the system includes more metadata in each offer to provide more robust bundling that will drive pricing. Below are a few examples:

Cast

Awards

Genre

Titles in wish list/shopping cart

### TV Season/Series Completion

According to exemplary embodiments, this is a special bundle/promotion that will recognize when a consumer is missing an episode in a season, or a season in a series, and provide a special offer to that consumer to complete their season/series. According to this exemplary embodiment, the digital locker (i.e., block 126 in FIGS. 2 and 3) feeds into the OMS to determine what is missing in order to create the appropriate promotion.

### Studio Driven Promotions/Pricing

According to exemplary embodiments, studios have access to the OMS via the same Magento portal that the offer management administrators use, but as a different user class. For example, studios are only able to see offer specifics to their content, and only have the ability to interact with a subset of features in the OMS, such as:

Bundling/Promotions

Price Updating

### Promotion Automation

According to exemplary embodiments, the OMS is integrated with both pre-processor and recommendation modules to drive on-the-fly offerings that are most relevant to the consumer. The intent of this feature is to create offers that will be purchased on impulse. Metaphorically, this level of automation will create a custom checkout line where personalized offers are merchandised to the consumer.

As described above, the present invention provides various methods and systems for providing a content workflow for media assets (e.g., video, audio and the like) include the ability to offer such content for sale to consumers. The invention can be implemented in a client/server environment where such media assets can be ingested and processed electronically prior to the offers for sale.

While this invention has been described as having a preferred design, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A method for operating a system, comprising:
receiving, via said system, a metadata file for at least one of audio and video content represented by a title; and
generating, via said system and in response to said metadata file, one or more software elements representing an offer to sell said content.

2. The method of claim 1, further comprised of offering said content for sale to a consumer.

3. The method of claim 2, wherein said offer for sale is based on at least one of a same series, a same studio and same actors from a past purchase by said consumer.

4. The method of claim 1, wherein said offer to sell includes a plurality of different formats of said content including at least a standard-definition format and a high-definition format.

5. The method of claim 1, wherein at least one of:
said system receives said metadata file directly from a studio in a client/server environment; and
said offer to sell is directly from said studio.

6. The method of claim 1, wherein said offer to sell includes a discount if a consumer buys said content in more than one format.

7. A system, comprising:
means for receiving a metadata file for at least one of audio and video content represented by a title; and
means for generating, in response to said metadata file, one or more software elements representing an offer to sell said content.

8. The system of claim 7, further comprising means for offering said content for sale to a consumer.

9. The system of claim 8, wherein said offer for sale is based on at least one of a same series, a same studio and same actors from a past purchase by said consumer.

10. The system of claim 7, wherein said offer to sell includes a plurality of different formats of said content including at least a standard-definition format and a high-definition format.

11. The system of claim 7, wherein at least one of:
said system receives said metadata file directly from a studio in a client/server environment; and
said offer to sell is directly from said studio.

12. The system of claim 7, wherein said offer to sell includes a discount if a consumer buys said content in more than one format.

13. A system, comprising:
an input operative to receive a metadata file for at least one of audio and video content represented by a title; and
a processor operative to generate, in response to said metadata file, one or more software elements representing an offer to sell said content.

14. The system of claim 13, further comprising means for offering said content for sale to a consumer.

15. The system of claim 14, wherein said offer for sale is based on at least one of a same series, a same studio and same actors from a past purchase by said consumer.

16. The system of claim 13, wherein said offer to sell includes a plurality of different formats of said content including at least a standard-definition format and a high-definition format.

17. The system of claim 13, wherein at least one of:
said system receives said metadata file directly from a studio in a client/server environment; and
said offer to sell is directly from said studio.

18. The system of claim 13, wherein said offer to sell includes a discount if a consumer buys said content in more than one format.
